(19) United States
(12) Patent Application Publication
(10) Pub. No.: US 2012/0139783 A1
(43) Pub. Date: Jun. 7, 2012

(54) Position Determining System Incorporating One or More Global Navigation Satellite System (GNSS) Antennas

(76) Inventors: Henry Morgan Hallam, Santa Cruz, CA (US); Ferguson MacPhorson Noble, Santa Cruz, CA (US)

(21) Appl. No.: 13/248,026

(22) Filed: Sep. 28, 2011

Related U.S. Application Data
(60) Provisional application No. 61/387,445, filed on Sep. 28, 2010.

(51) Int. Cl. G01S 19/42

(52) U.S. Cl. 342/357.25

(57) ABSTRACT

A system for determining position, velocity, time, and/or altitude of a vehicle of object using GNSS under a broad range of dynamic conditions. The system may utilize a plurality of antennas in some aspects. In some aspects, the system may operate in a differential mode incorporating a fixed or mobile base station. In some aspects, the system may be connected to a smart phone, tablet, or other mobile computing device.

### CROSS-REFERENCE TO RELATED APPLICATIONS

This application claims priority to U.S. Provisional Patent Application No. 61/387,445 to Hallam, filed Sep. 28, 2010, which is hereby incorporated by reference in its entirety.

### BACKGROUND

Field of the Invention

The present invention relates to position determination using a GNSS system.

### SUMMARY

A system for determining position, velocity, time, and/or altitude of a vehicle of object using GNSS under a broad range of dynamic conditions. The system may utilize a plurality of antennas in some aspects. In some aspects, the system may operate in a differential mode incorporating a fixed or mobile base station. In some aspects, the system may be connected to a smart phone, tablet, or other mobile computing device.

### BRIEF DESCRIPTION OF THE DRAWINGS

FIG. 1 is a schematic diagram of a tight integration architecture according to some embodiments of the present invention.

FIG. 2 is a schematic diagram of an alternative tight integration architecture according to some embodiments of the present invention.

FIG. 3 is a diagram of a receiver front end according to some embodiments of the present invention.

FIG. 4 illustrates a system according to some embodiments of the present invention.

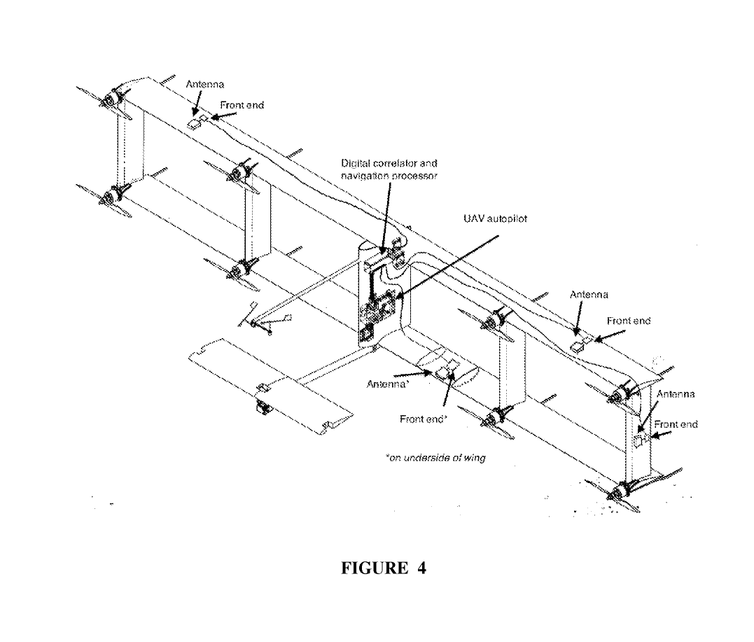

FIG. 5 illustrates a system according to some embodiments of the present invention.

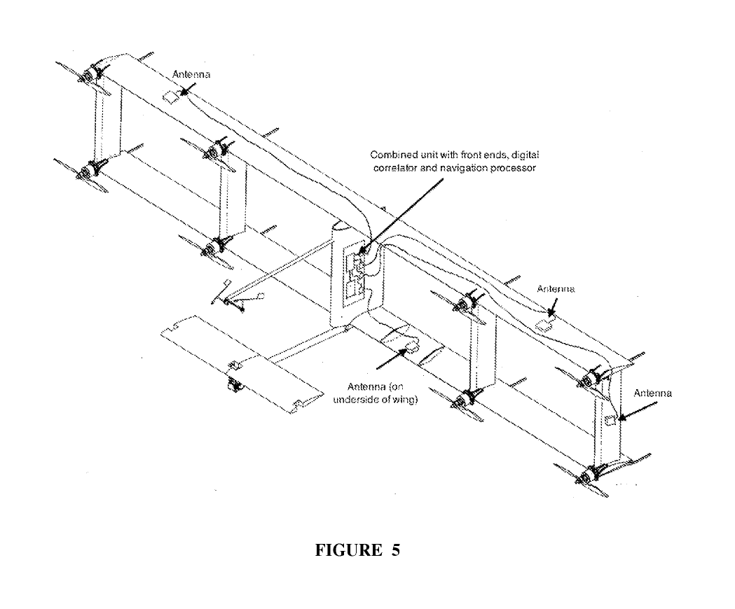

### DETAILED DESCRIPTION

In some embodiments of the present invention, a system for determining position, velocity, time and/or attitude of a vehicle or object (“platform”) using GNSS under a broad range of dynamic conditions may utilize a plurality of antennas. The system may include some or all of the following elements.

Optional use of multiple antennas.

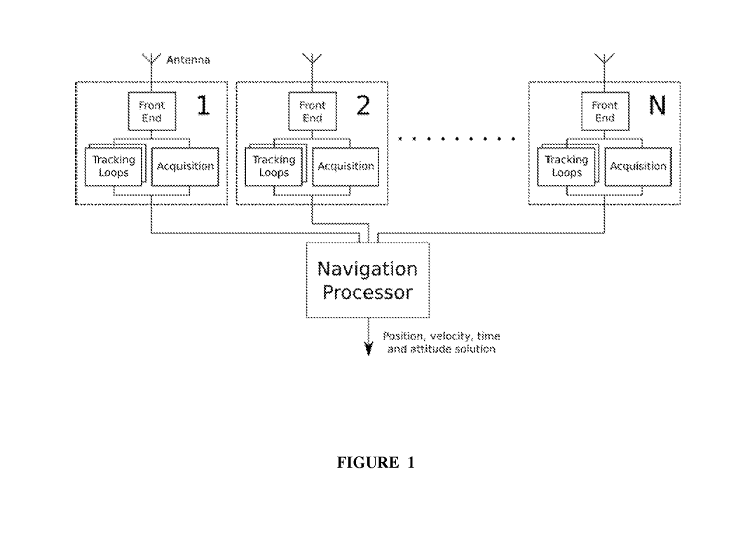

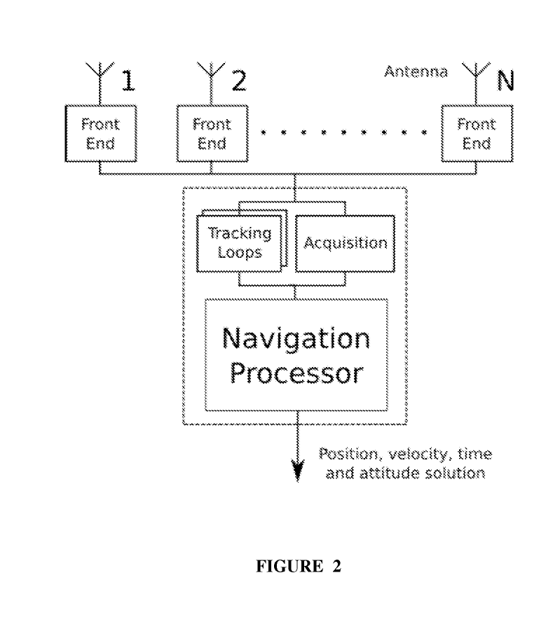

“Tight integration”, before navigation solution, as shown in FIGS. 1 and 2. This allows the combined system to produce navigation solutions even when no single antenna has enough satellites visible for a solution. [existing multiple-antenna systems have a complete independent receiver for each antenna, which leads to limitations].

Two possible architectures are envisioned, each antenna has a dedicated front-end but the tracking and acquisition functions may be integrated with the front-end in a single module, one per antenna, as shown in FIG. 1. Alternatively, the tracking and acquisition functions may be performed by a single processing unit that services all of the front-ends as shown in FIG. 2.

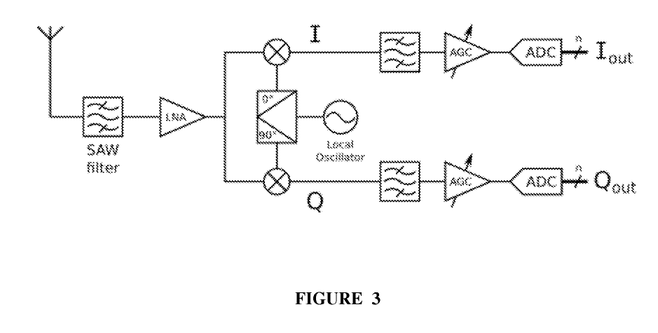

In some embodiments, multiple antennas provide continuous coverage even as the platform rotates to different attitudes. As some antennas lose sky view/satellite visibility due to the platform's rotation, the satellites become visible to other antennas. Multiple antennas may allow determination of platform attitude without needing an inertial measurement unit (IMU). If an IMU is present, information from multiple antennas may be combined with IMU-derived information to form a fused navigation solution. Each antenna is connected to a dedicated front end incorporating a super-heterodyne receiver and analog-to-digital converter (ADC), as shown in FIG. 3.

In some embodiments, the front end optionally includes a digital down-converter with a low-IF or zero-IF complex digital output. Front end optionally includes one or more surface acoustic wave (SAW) filters for interference suppression. ADC may have real or complex (I/Q output [complex output allows simplification of tracking loop design]. ADC may have single or multiple bit output [multiple bits allow better sensitivity and interference-mitigation techniques by avoiding ADC saturation]

In some embodiments, front ends are connected to one or more digital correlator units which performs carrier and code removal, signal tracking and acquisition functions for each satellite observation. The digital correlator may be implemented in ASIC, CPU, DSP or FPGA. The digital correlator may optionally be combined with navigation processor in a single chip. Digital correlators may be shared between tracking and acquisition functions or may be dedicated individually to either tracking or acquisition. Tracking loops may be based on frequency-locked loop, phase-locked loop or Costas loop algorithms.

In some embodiments, the tracking loop bandwidth may be automatically adjusted with varying signal strength and platform dynamics to ensure maximum signal-to-noise ratio, noise immunity and ability to maintain lock under rapid accelerations. Digital correlator(s) are connected to a navigation processor which determines position, velocity, time and/or attitude solution from satellite observation measurements.

The navigation processor may assist acquisition functions in the digital correlators by using known or previously recorded satellite almanac and ephemeris data. This information may be provided to the navigation processor from a base station as discussed in section 6 or may be downloaded from the Internet if an Internet connection is present. If an IMU is present, the navigation processor may use inertial measurements made by the IMU to aid the tracking loops by estimating the platform position, velocity and/or attitude at the next tracking loop iteration.

The navigation processor may utilize any of several algorithms to determine the position, velocity, time and/or attitude solution. Suitable algorithms include Batch Least Squares and Unscented, Extended or Regular Kalman filters. In a multiple antenna system the carrier phase information is compensated with the known baselines to each of the antennas on the platform relative to a fixed datum point.

The navigation processor may also utilize the navigation solution (optionally fused with IMU-derived information) to calculate “super hot start” parameters (code phase and Doppler frequency) for new satellites before they appear above the horizon of each antenna, allowing instantaneous acquisition. The navigation solution may be computed in real time (<10 milliseconds from observation to navigation solution) for use in high-bandwidth control systems.

The system may optionally operate in differential mode incorporating a fixed or mobile base station. The base station determines satellite pseudo-range errors to enhance precision of platform navigation solution. A unidirectional or bidirectional communications link may exist between base station and platform navigation processor. Examples include a wired connection, a dedicated radio link, a software channel “piggybacked” on an existing radio link used for other purposes, or a cellular modem. Base station assists the platform receiver with rapid satellite acquisition by up-linking one or more of: almanac data, ephemeris data, approximate position, approximate time. These reduce the search space required to lock onto the satellite signal.

Both or either of the standalone system or the fixed or mobile base station in differential mode my be connected to a smart phone, tablet or other mobile computing device. The mobile computing device may be used to provide the navigation processor with almanac, ephemeris and/or approximate position and time data either downloaded via the mobile device's internet connection or from information stored or derived locally on the device. The mobile device may communicate with the system over a wired connection or wireless connection using a radio link for example Bluetooth or Wifi. The mobile device may provide a user interface by which the user of the system can view, record or analyze the navigation solution output by the system. The mobile device may also provide a user interface by which the user can view and edit the parameters of the system and monitor the performance and health status of the system.

As evident from the above description, a wide variety of embodiments may be configured from the description given herein and additional advantages and modifications will readily occur to those skilled in the art. The invention in its broader aspects is, therefore, not limited to the specific details and illustrative examples shown and described. Accordingly, departures from such details may be made without departing from the spirit or scope of the applicant's general invention.

What is claimed is:

1. A positioning system, said positioning system comprising:
a plurality of antennas adapted for GNSS reception;
a plurality of front end portions, said front end portions adapted to translate radio signals received by said antennas into digital representation of the radio signals, wherein each of said front end portions coupled to one of said plurality of antennas;
a first navigation processor, wherein each of said front end portions is electrically coupled to said first navigation processor, wherein said is adapted to process the signals received from said plurality of antennas and to calculate position based upon said signals.

2. A method for determining navigation solutions, said method comprising the steps of:
receiving radio signals from a GNSS network on two or more antennas,
routing the received signal from each antenna to a dedicated front end portion, wherein front end portions adapted to translate radio signals received by said antennas into digital representation of the radio signal,
routing the output of each front portion to a first digital correlator unit,
determining a navigation solution in a navigation computer, wherein said navigation computer is in communication with said first digital correlator unit.

3. A method for determining navigation solutions, said method comprising the steps of:
receiving radio signals from a GNSS network on two or more antennas,
routing the received signal from each antenna to a dedicated front end portion, wherein front end portions adapted to translate radio signals received by said antennas into digital representation of the radio signal,
routing the output of each front portion to a dedicated digital correlator unit,
determining a navigation solution in a navigation computer, wherein said navigation computer is in communication with each of said dedicated digital correlator units.
